(19) United States
(12) Patent Application Publication
(10) Pub. No.: US 2026/0267762 A1
(43) Pub. Date: Sep. 10, 2026

(54) SYSTEM

(71) Applicant: SOFTBANK GROUP CORP., Tokyo (JP)

(72) Inventor: Koji OKUDA, Tokyo (JP)

(73) Assignee: SOFTBANK GROUP CORP., Tokyo (JP)

(21) Appl. No.: 19/555,280

(22) Filed: Mar. 3, 2026

Related U.S. Application Data
(60) Provisional application No. 63/766,573, filed on Mar. 4, 2025.

(51) Int. Cl. G06F 11/34; H04N 21/8545

(52) U.S. Cl. CPC G06F 11/3438; H04N 21/8545

(57) ABSTRACT

A system for streamlining user PC operations and enhancing work productivity is disclosed. This system comprises a monitoring unit, an analysis unit, a generation unit, and a learning unit. It monitors user operations in real time and collects operation logs. The analysis unit analyzes the operation logs using machine learning algorithms to identify patterns in the user's workflows and tasks. The generation unit proposes optimal operation procedures and task priorities based on the analysis results to support the user's work. The learning unit continuously improves proposal accuracy based on user feedback. This enables users to receive personalized support tailored to their work style, thereby achieving work efficiency.

### CROSS-REFERENCE TO RELATED APPLICATION

This application claims priority under 35 U.S.C. § 119 to U.S. Provisional Patent Application No. 63/766,573, filed on March 4, 2025, the entire contents of which are incorporated herein by reference.

### BACKGROUND

### Technical Field

The present disclosure relates to a system.

### Related Art

Japanese Patent Application Publication Laid-Open (JP-A) No. 2022-180282 discloses a persona chatbot control method performed by at least one processor, comprising: a step of receiving a user utterance; a step of adding to the user utterance a prompt containing a description of the chatbot's persona and related instructions; a step of encoding the prompt; and a step of inputting the encoded prompt into a language model to generate a chatbot utterance in response to the user utterance.

### SUMMARY

Systems and methods for solving the inefficiency in PC operations routinely performed by working adults and the need to improve work productivity is disclosed. Specifically, in modern work environments, PC operations are closely related to many tasks, and the complexity of these operations often becomes a factor reducing work efficiency. Conventional methods made it difficult to manually optimize individual operations, and means for users to objectively understand and improve their own workflows were limited.

Furthermore, challenges existed in how to link the analysis results from task mining tools to actual operational improvements. Conventional task mining was limited to collecting and analyzing operation logs, leaving the utilization of these results to the user's discretion. This made it difficult to translate the findings into concrete operational improvements.

Ways to enhance work efficiency by combining task mining with generative AI is discussed. It achieves this by monitoring users' PC operations in real time, analyzing operation logs to identify their workflow, and proposing optimal operation procedures and task priorities.

This enables users to receive personalized support tailored to their work style, providing an experience akin to having a personal assistant. In this way, it aims to improve work productivity while reducing the user's burden.

As a means to solve the problem, a system comprising: a monitoring unit that monitors the user's PC operations in real time and collects operation logs; an analysis unit that analyzes the collected operation logs and identifies the user's workflow; a generation unit that proposes optimal operation procedures and task priorities to the user based on the analysis results; and a learning unit that receives feedback from the user and improves the proposal accuracy of the generation unit is provided. This system enables accurate identification of user work patterns by continuously monitoring user PC operations and recording detailed operation logs. The analysis unit analyzes operation logs using machine learning algorithms and identifies frequently performed workflows and task patterns. This enables the generation unit to propose efficient operation procedures and task priorities to the user, thereby improving work efficiency. Furthermore, the learning unit improves proposal accuracy based on user feedback, providing personalized support tailored to the user's work style. In this way, the system aims to support the user's work and provide an experience akin to having a personal assistant.

### BRIEF DESCRIPTION OF THE DRAWING

FIG. 1 is a conceptual diagram showing an example configuration of the data processing system according to the first embodiment.

FIG. 2 is a conceptual diagram showing an example of key functions of the data processing device and smart device according to the first embodiment.

FIG. 3 is a conceptual diagram showing an example configuration of the data processing system according to the second embodiment.

FIG. 4 is a conceptual diagram showing an example of the main functions of the data processing device and smart glasses according to the second embodiment.

FIG. 5 is a conceptual diagram showing an example configuration of a data processing system according to a third embodiment.

FIG. 6 is a conceptual diagram showing an example of the main functions of the data processing device and headset-type terminal according to the third embodiment.

FIG. 7 is a conceptual diagram showing an example configuration of a data processing system according to the fourth embodiment.

FIG. 8 is a conceptual diagram showing an example of the main functions of the data processing device and robot according to the fourth embodiment.

FIG. 9 shows an emotion map onto which multiple emotions are mapped.

FIG. 10 shows an emotion map onto which multiple emotions are mapped.

### DETAILED DESCRIPTION

The following describes an example embodiment of a system according to the present disclosure with reference to the accompanying drawings.

First, the terminology used in the following description is explained.

In the following embodiments, a processor (hereinafter simply referred to as a "processor") may be a single arithmetic unit or a combination of multiple arithmetic units. Furthermore, the processor may be a single type of arithmetic unit or a combination of multiple types of arithmetic units. Examples of processing units include a CPU (Central Processing Unit), a GPU (Graphics Processing Unit), a GPGPU (General-Purpose Computing on Graphics Processing Units), an APU (Accelerated Processing Unit), and the like.

In the following embodiments, signed RAM (Random Access Memory) is a memory where information is temporarily stored and is used as working memory by the processor.

In the following embodiments, the signed storage is one or more non-volatile storage devices that store various programs and various parameters, etc. Examples of non-volatile storage devices include flash memory (SSD (Solid State Drive)), magnetic disks (e.g., hard disk), or magnetic tape.

In the following embodiments, the communication I/F (Interface) is an interface including a communication processor and an antenna, etc. The communication I/F governs communication between multiple computers. Examples of communication standards applicable to the communication I/F include wireless communication standards such as 5G (5^{th} Generation Mobile Communication System), Wi-Fi (registered trademark), or Bluetooth (registered trademark).

In the following embodiments, "A and/or B" is synonymous with "at least one of A and B." That is, "A and/or B" may mean A alone, B alone, or a combination of A and B. Furthermore, in this specification, when three or more items are connected using "and/or," the same concept applies as for "A and/or B".

### First Embodiment

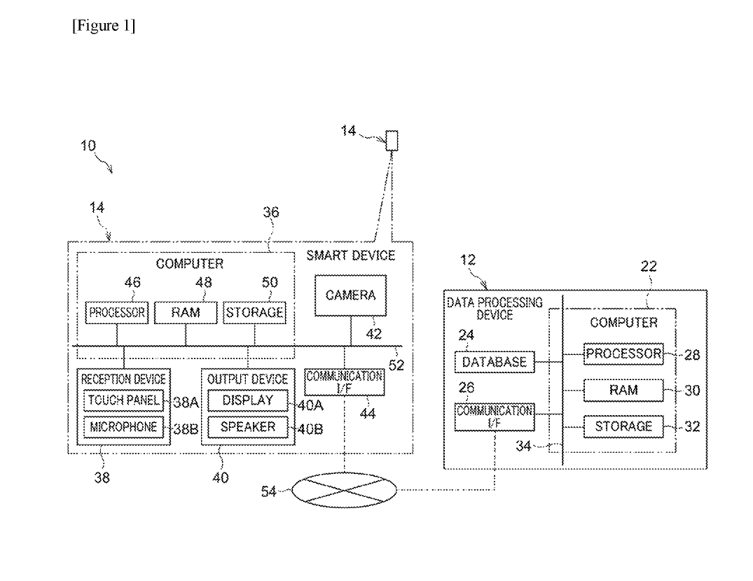

FIG. 1 shows an example configuration of a data processing system 10 according to the first embodiment.

As shown in FIG. 1, the data processing system 10 includes a data processing device 12 and a smart device 14. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart device 14 includes a computer 36, a reception device 38, an output device 40, a camera 42, and a communication I/F 44. The computer 36 includes a processor 46, RAM 48, and storage 50. The processor 46, RAM 48, and storage 50 are connected to a bus 52. The reception device 38, output device 40, and camera 42 are also connected to the bus 52. The reception device 38, output device 40, and camera 42 are also connected to the bus 52.

The reception device 38 includes a touch panel 38A and a microphone 38B, among other components, and receives user input. The touch panel 38A receives user input via contact with an indicator (e.g., a pen or finger) by detecting such contact. The microphone 38B receives voice-based user input by detecting the user's voice. The control unit 46A transmits data indicating the user input received via the touch panel 38A and microphone 38B to the data processing device 12. Within the data processing device 12, the specific processing unit 290 acquires the data indicating the user input.

Output device 40 includes display 40A and speaker 40B, among others, presenting data to user 20 by outputting it in a perceptible form (e.g., audio and/or text). Display 40A displays visual information such as text and images according to instructions from processor 46. Speaker 40B outputs audio according to instructions from processor 46. Camera 42 is a compact digital camera equipped with an optical system including a lens, aperture, and shutter, and an imaging element such as a CMOS (Complementary Metal-Oxide-Semiconductor) image sensor or a CCD (Charge Coupled Device) image sensor.

The communication interface 44 is connected to the network 54. The communication interfaces 44 and 26 manage the exchange of various information between processor 46 and processor 28 via network 54.

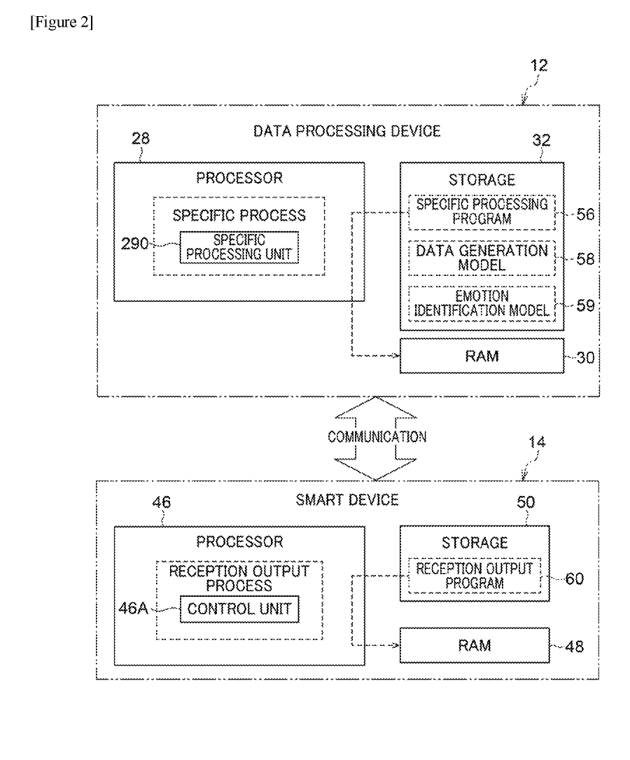

FIG. 2 shows an example of the main functions of the data processing device 12 and the smart device 14.

As shown in FIG. 2, specific processing is performed by processor 28 in data processing device 12. Specific processing program 56 is stored in storage 32. Specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

The smart device 14 performs reception output processing via the processor 46. The reception output program 60 is stored in the storage 50. The reception output program 60 is used in conjunction with the specific processing program 56 by the data processing system 10. The processor 46 reads the reception output program 60 from the storage 50 and executes the read reception output program 60 on the RAM 48. The specific processing is performed by the processor 46 operating as a control unit 46A according to the specific processing program 60 executed on the RAM 48. Note that the smart device 14 may also have data generation models and emotion identification models similar to the data generation model 58 and emotion identification model 59, and may perform processing similar to that of the specific processing unit 290 using these models. The reception output processing is realized by the processor 46 operating as the control unit 46A according to the reception output program 60 executed on the RAM 48.

Other devices besides the data processing device 12 may also have the data generation model 58. For example, a server device (e.g., a generation server) may have the data generation model 58. In this case, the data processing device 12 communicates with the server device having the data generation model 58 to obtain processing results (such as prediction results) obtained using the data generation model 58. Furthermore, the data processing device 12 may be the server device itself, or it may be a terminal device owned by a user (e.g., a mobile phone, robot, home appliance, etc.). Next, an example of processing by the data processing system 10 according to the first embodiment will be described.

### Example 1

The flow of the specific processing in Example 1 is described below. The components of the system described below are implemented by the data processing device 12 and the smart device 14. The data processing device 12 is referred to as the "server," and the smart device 14 is referred to as the "terminal."

### Implementation Examples for Carrying Out the Invention

As an embodiment for implementing the present invention, the system is configured using a server and a terminal. Details are further explained below.

First, the monitoring unit is implemented on the terminal, which is the user's PC. Dedicated software is installed on this terminal to monitor the user's operations in real time. This software runs in the background while the user uses the PC, recording the user's operations in detail. Specifically, it collects information such as which applications the user opened, which commands they executed, what data they entered, which buttons they clicked, which files they created or edited, and which emails they sent or received. For example, a sequence of operations where the user opens word processing software to create a document, then attaches that document to an email and sends it, is recorded. Similarly, if a user analyzes data using spreadsheet software and reports the results using presentation software, all these operations are also recorded.

Next, the collected operation logs are securely transmitted from the terminal to the server. This transmission is encrypted to maintain data confidentiality. The server is equipped with an analysis unit where the operation logs are analyzed. The analysis unit uses machine learning algorithms to analyze the user's operation logs and identify business flow and task patterns. For example, if a user frequently performs a sequence of operations such as checking specific emails every morning followed by opening a spreadsheet to input data, this pattern is recognized. Furthermore, if a user tends to use specific applications during particular time periods, tasks related to those time periods are prioritized for suggestion. Additionally, the analysis unit includes an anomaly detection function capable of detecting operations deviating from normal business workflows and alerting the user.

The analysis results are passed to the generation unit. The generation unit is also implemented on the server and proposes optimal operation sequences or task priorities to the user based on the analysis results. Specifically, when the user opens a specific application on their device, it displays the next recommended action via a pop-up. For example, when the user opens the email application, it pops up the spreadsheet they should open next on the screen. Additionally, notifications are displayed on the screen to remind users of tasks they are likely to forget. Furthermore, macros are automatically generated to enable efficient switching between multiple applications, allowing execution with a single click. For example, if a user extracts data using database software, then graphs that data to create a report, a macro is generated to execute all these operations at once.

Finally, the learning unit is located on the server and receives feedback from users. It records whether users accepted suggestions and whether the suggestions were helpful, continuously learning to improve the generation unit's suggestion accuracy. For instance, if a user frequently accepts a specific suggestion, the system adjusts to make that suggestion more frequently. If a user rejects a suggestion, the system analyzes the reason and incorporates it into future suggestions. Furthermore, the learning unit detects changes in the user's work style and can dynamically update suggestion content accordingly.

I n this way, a system is realized where the server and terminal collaborate to support the user's work. This system aims to provide personalized support tailored to the user's work style and to enhance work efficiency. As a specific example, when a user starts a new project, the system can propose an optimal task sequence based on data from similar past projects. Furthermore, when a user manages multiple projects simultaneously, the system automatically lists priority tasks for each project, supporting efficient project management. In this way, the system comprehensively supports the user's work, aiming to provide an experience akin to having a personal assistant.

### System Configuration

The system according to this embodiment comprises a monitoring unit, an analysis unit, a generation unit, and a learning unit. The monitoring unit monitors the user's PC operations in real time and collects operation logs. Specifically, it records detailed information such as which applications the user opened on the PC, which commands they executed, what data they entered, which buttons they clicked, which files they created or edited, and which emails they sent or received. For example, a sequence of operations where a user opens word processing software to create a document, attaches that document to an email, and sends it is recorded. Similarly, if a user analyzes data using spreadsheet software and reports the results using presentation software, all these operations are recorded. Furthermore, if a user extracts data using database software, graphs that data, and creates a report, the monitoring unit records these operations without omission.

The analysis unit analyzes the operation logs sent from the monitoring unit to identify the user's workflow and task patterns. The analysis unit uses machine learning algorithms to analyze the user's operation logs. For example, if a user frequently performs a sequence of actions such as checking specific emails every morning and then opening a spreadsheet to input data, this pattern is recognized. Furthermore, if a user tends to use specific applications during particular time periods, the system prioritizes suggesting tasks related to those time periods. Additionally, the analysis unit incorporates anomaly detection capabilities, enabling it to detect operations deviating from normal workflow patterns and alert the user. For instance, if a user suddenly performs an operation they typically do not perform, the analysis unit detects this operation and issues a warning to the user, as it could potentially impact business operations.

The generation unit proposes optimal operation sequences and task priorities to the user based on analysis results obtained from the analysis unit. The generation unit displays the next recommended operation as a pop-up when the user opens a specific application on their terminal. For example, when the user opens an email application, it pops up the spreadsheet they should open next on the screen. It also displays notifications on the screen to remind users of tasks they are prone to forget. Furthermore, it automatically generates macros to enable efficient switching between multiple applications, allowing execution with a single click. For instance, if a user extracts data from database software, graphs that data, and creates a report, it generates a macro to execute all these operations at once. Specific examples of prompts fed to the generation AI include: "Predict the next action a user will take after opening email and suggest the optimal spreadsheet," or "Analyze the user's workflow and suggest efficient task combinations."

The learning unit receives feedback from users and continuously learns to improve the proposal accuracy of the generation unit. It records whether users accepted proposals and whether the proposals were helpful, reflecting this information in future proposals. For example, if a user frequently accepts a specific proposal, the system adjusts to make that proposal more frequently. Furthermore, if a user rejects a proposal, the system analyzes the reason and incorporates this into future proposals. Furthermore, the Learning Unit detects changes in the user's work style and can dynamically update proposal content accordingly. For instance, when a user starts a new project, it can suggest the optimal task sequence based on data from similar past projects. When a user manages multiple projects simultaneously, it can automatically list priority tasks for each project within the project management system, supporting efficient project management. In this way, the system aims to comprehensively support the user's work, providing an experience akin to having a personal assistant. In this way, the system aims to provide comprehensive support for the user's work, offering an experience akin to having a personal assistant.

### Implementation Steps

### Step 1: Monitoring and Collecting Operation Logs

Dedicated software running on the user's PC monitors their operations in real time. This software records detailed information such as which applications the user opened, which commands they executed, what data they entered, which buttons they clicked, which files they created or edited, and which emails they sent or received. For example, a sequence of operations where the user opens word processing software to create a document, then attaches that document to an email and sends it, is recorded. Similarly, if a user analyzes data using spreadsheet software and reports the results using presentation software, all these operations are also recorded.

### Step 2: Analysis of Operation Logs

The collected operation logs are sent to the server and analyzed by the analysis unit. The analysis unit uses machine learning algorithms to analyze the user's operation logs and identify business flow and task patterns. For example, if a user frequently performs a sequence of actions such as checking specific emails every morning and then opening a spreadsheet to input data, this pattern is recognized. Furthermore, if a user tends to use specific applications during particular time periods, tasks related to those time periods are prioritized for suggestion. Additionally, the analysis unit includes an anomaly detection function, enabling it to detect operations deviating from normal business workflows and alert the user.

### Step 3: Proposals via Generative AI

Based on the analysis results, the generation unit proposes optimal operation sequences and task priorities to the user. When the user opens a specific application on their device, the generation unit displays a pop-up showing the next recommended action. For example, when the user opens the email application, it pops up the spreadsheet they should open next on the screen. It also displays notifications on the screen to remind users of tasks they are prone to forget. Furthermore, it automatically generates macros to enable efficient switching between multiple applications, allowing execution with a single click. Specific examples of prompts fed to the generative AI include: "Predict the next action a user should take after opening email and suggest the optimal spreadsheet," or "Analyze the user's workflow and suggest efficient task combinations."

### Step 4: Learning from Feedback

The learning unit receives feedback from users and continuously learns to improve the proposal accuracy of the generation unit. It records whether users accepted proposals and whether the proposals were helpful, reflecting this in future proposals. For example, if a user frequently accepts a specific proposal, the system adjusts to make that proposal more frequently. If a user rejects a proposal, the system analyzes the reason and incorporates it into future proposals. Furthermore, the Learning Unit can detect changes in the user's work style and dynamically update proposal content accordingly. For example, when a user starts a new project, it can propose an optimal task sequence based on data from similar past projects. When a user manages multiple projects simultaneously, it can automatically list priority tasks for each project, supporting efficient project management.

### Specific Use Cases

Consider implementing the present invention to support the daily tasks of a sales representative at a company. This sales representative performs a routine workflow: checking customer emails each morning, entering progress status for each customer into a spreadsheet, and then creating presentation materials for customer meetings. To streamline this workflow, the system operates as follows.

First, the monitoring unit observes the sales representative's PC operations in real time and collects operation logs. Specifically, it records actions such as launching the email application, entering data in spreadsheet software, and creating materials in presentation software. This clarifies the sequence in which the sales representative performs their tasks.

Next, the analysis unit analyzes the collected operation logs to identify the sales representative's workflow. The analysis unit uses machine learning algorithms to recognize patterns in the sequence of operations performed by the sales representative each morning. It also identifies operations frequently performed for specific customers or during specific time periods, aiming to improve workflow efficiency based on these patterns.

Based on the analysis results, the generation unit proposes optimal operation procedures and task priorities to the sales representative. For example, when the sales representative opens the email application, it pops up the spreadsheet they should open next on the screen. It also automatically suggests templates needed for creating presentation materials, supporting more efficient document creation. Furthermore, it generates macros for updating progress status for each customer in bulk, enabling execution with a single click.

The Learning Unit receives feedback from sales representatives and continuously learns to improve the Generation Unit's proposal accuracy. It records whether a sales representative accepted a proposal and whether the proposal was helpful, reflecting this in future proposals. For example, if a sales representative frequently accepts a specific proposal, the system adjusts to make that proposal more frequently. Furthermore, if a sales representative rejects a proposal, the system analyzes the reason and reflects this in future proposals.

Specific examples of prompts fed to the generative AI include: "Predict the next action a sales representative will take after opening an email and propose the optimal spreadsheet" or "Analyze the sales representative's workflow and propose an efficient combination of tasks." In this way, the system aims to comprehensively support sales representatives' work and enhance operational efficiency.

### Application Example 1

The flow of specific processing in Application Example 1 is described below. The components of the system described below are implemented by the data processing device 12 and the smart device 14. The data processing device 12 is referred to as the "server," and the smart device 14 is referred to as the "terminal."

### Implementation Examples for the Present Invention

As an embodiment for implementing the present invention, a system for improving work efficiency in a logistics center is described in detail. This system comprises a monitoring unit, an analysis unit, a generation unit, and a learning unit, with each unit cooperating to optimize worker movements and work procedures.

First, the monitoring unit uses multiple sensors and cameras installed within the logistics center to capture worker movements. Monitor workers' movements and procedures in real time. Specifically, cameras placed along aisles and shelves throughout the distribution center track workers' paths, recording in detail which shelves they pick items from and which routes they take to the packing area. For example, it records the sequence of movements where a worker retrieves an item from shelf A, passes by shelves B and C, and proceeds to the packing area. Additionally, the procedures and tools used by workers during packaging operations are also recorded. This accumulates the worker's entire sequence of movements as digital data.

Next, the analysis unit analyzes the work logs transmitted from the monitoring unit. The analysis unit uses machine learning algorithms to identify patterns in worker movements and work procedures. For example, if a worker consistently takes the same route, it determines whether that route is optimal and suggests more efficient routes. Furthermore, when multiple workers perform tasks simultaneously, it can optimize their paths to prevent movement routes from intersecting. Furthermore, the analysis unit includes an anomaly detection function that can detect operations deviating from the normal workflow and alert the worker. For example, it can detect when a worker takes a route not normally used or when a task is taking longer than usual, suggesting areas for improvement.

The generation unit proposes optimal movements and work procedures to workers based on analysis results obtained from the analysis unit. For example, it provides navigation to ensure workers take the shortest route when picking items. When picking multiple items at once, it suggests the optimal sequence to minimize travel distance. Furthermore, during packing operations, it proposes efficient procedures to improve work speed. The generation unit displays the proposals on the terminal used by the worker, supporting the worker in performing tasks according to the proposals. For example, it guides the worker's movements by displaying specific instructions on the terminal, such as "Next, please pick the item from shelf B."

The learning unit receives feedback from workers and continuously learns to improve the generation unit's proposal accuracy. It records whether workers accepted proposals and whether the proposals were helpful, reflecting this in future proposals. For example, if a worker frequently accepts a specific proposal, the system adjusts to make that proposal more frequently. Furthermore, if an operator rejects a suggestion, the system analyzes the reason and incorporates this into future suggestions. Additionally, the learning unit can detect changes in the work environment within the logistics center and dynamically update suggestion content accordingly. For example, it can respond quickly when new products are added or shelf layouts are changed, proposing optimal work procedures.

In this way, the system comprehensively supports operations within the logistics center, enabling operational efficiency. Its purpose is to reduce worker burden and improve overall productivity. As a specific example, when an operator handles a new product, the system can propose the optimal picking sequence based on historical data for similar products. Furthermore, when an operator processes multiple orders simultaneously, the system automatically lists priority tasks for each order, supporting efficient work. In this way, the system aims to optimize operations within the logistics center, providing an experience akin to having a personal assistant.

### System Configuration

The system according to this embodiment comprises a monitoring unit, an analysis unit, a generation unit, and a learning unit. The monitoring unit uses multiple sensors and cameras installed within the logistics center to monitor workers' movements and work procedures in real time. Specifically, cameras placed in each aisle and at each shelf within the logistics center track workers' movement paths, recording in detail which shelves they pick items from and which routes they take to move to the packing area. For example, it records a worker's sequence of actions: retrieving goods from shelf A, passing through shelves B and C, and proceeding to the packing area. It also records the procedures and tools used when performing packing tasks. The procedures and tools used during the packing process are also recorded. This accumulates the worker's entire sequence of movements as digital data.

The analysis unit analyzes the work logs transmitted from the monitoring unit. Using machine learning algorithms, the analysis unit identifies patterns in worker movements and work procedures. For example, if a worker consistently takes the same route, it determines whether that route is optimal and suggests more efficient alternatives. Furthermore, when multiple workers operate simultaneously, it can optimize their paths to prevent movement conflicts. Furthermore, the analysis unit includes an anomaly detection function. It can detect operations deviating from the normal workflow and alert the worker. For example, it can detect when a worker takes a route not normally used or when a task takes longer than usual, suggesting areas for improvement.

The generation unit proposes optimal movements and work procedures to workers based on analysis results obtained from the analysis unit. For example, it provides navigation to ensure workers take the shortest route when picking items. When picking multiple items at once, it suggests the optimal sequence to minimize travel distance. Furthermore, during packing operations, it proposes efficient procedures to improve work speed. The generation unit displays the proposals on the worker's terminal, supporting the worker in performing tasks according to the suggestions. For example, it guides the worker's movements by displaying specific instructions on the terminal, such as "Next, pick the item from shelf B." Specific examples of prompt sentences fed to the generative AI include "Propose the optimal sequence for the worker when picking items" and "Propose an efficient procedure for packaging tasks."

The learning unit receives feedback from workers and continuously learns to improve the proposal accuracy of the generation unit. It records whether workers accepted a proposal and whether the proposal was helpful, reflecting this information in future proposals. For example, if a worker frequently accepts a specific proposal, the system adjusts to make that proposal more frequently. Furthermore, if an operator rejects a suggestion, the system analyzes the reason and incorporates this into future suggestions. Additionally, the Learning Unit can detect changes in the work environment within the logistics center and dynamically update suggestions accordingly. For instance, it can swiftly respond to new product additions or shelf layout changes by proposing the optimal work sequence. In this way, the system comprehensively supports operations within the logistics center, enabling operational efficiency. The goal is to reduce worker burden and improve overall productivity. As a concrete example, when a worker handles a new product, the system can propose the optimal picking sequence based on historical data for similar products. Furthermore, when a worker processes multiple orders simultaneously, the system automatically lists priority tasks for each order, supporting efficient work. In this way, the system aims to optimize operations within the logistics center, providing an experience akin to having a personal assistant.

### Implementation Steps

### Step 1: Monitoring and Collecting Work Logs

Multiple sensors and cameras installed within the logistics center monitor workers' movements and procedures in real time. Specifically, cameras placed in each aisle and at each shelf track workers' paths, recording in detail which shelves they pick items from and which routes they take to move to the packing area. For example, it records a worker's sequence of actions: taking an item from shelf A, then moving via shelves B and C to the packing area. Additionally, the procedures and tools used by workers during packaging operations are also recorded. This accumulates the worker's entire sequence of movements as digital data.

### Step 2: Analysis of Work Logs

Analyze the work logs transmitted from the monitoring unit. The analysis unit uses machine learning algorithms to identify patterns in worker movements and work procedures. For example, if a worker consistently takes the same route, it determines whether that route is optimal and suggests more efficient routes. Furthermore, when multiple workers perform tasks simultaneously, it can optimize their paths to prevent crossing. Furthermore, the analysis unit incorporates anomaly detection capabilities, enabling it to detect operations deviating from normal workflow and alert the worker.

### Step 3: Proposals via Generative AI

Based on the analysis results obtained from the analysis unit, the generation unit proposes optimal movements and work procedures to the worker. For example, when a worker picks items, it provides navigation to ensure they take the shortest route. When picking multiple items at once, it suggests the optimal order to minimize travel distance. Furthermore, during packing operations, it proposes efficient procedures to improve work speed. The generation unit displays these suggestions on the worker's terminal, supporting them in performing tasks according to the recommendations. Specific examples of prompts fed to the generative AI include: "Propose the optimal sequence for workers picking items" or "Propose efficient procedures for packaging operations."

### Step 4: Learning from Feedback

Receive feedback from workers and continuously learn to improve the accuracy of the Generation Unit's suggestions. Record whether workers accepted a suggestion and whether it was helpful, reflecting this in future suggestions. For example, if a worker frequently accepts a specific suggestion, adjust to make that suggestion more proactive. Furthermore, if an operator rejects a suggestion, the reason is analyzed and reflected in future suggestions. Additionally, the learning unit can detect changes in the work environment within the logistics center and dynamically update the content of suggestions accordingly. For example, it can respond quickly when new products are added or shelf layouts are changed, proposing optimal work procedures.

### Specific Use Cases

For example, consider implementing the present invention to optimize the process where workers in a logistics center perform daily tasks of picking, packing, and preparing goods for shipment. In this logistics center, diverse products are arranged on shelves, and workers must accurately and quickly pick items according to orders. Here, the system monitors workers' movements and work procedures in real time to achieve optimization.

The monitoring unit uses cameras and sensors installed within the logistics center to record workers' movement paths in detail. It monitors a worker's sequence of actions—such as retrieving a product from shelf A, passing through shelves B and C, and proceeding to the packing area—accumulating data on which route is most efficient. It also records the procedures and tools used during packing operations, comprehensively capturing the workflow.

The analysis unit analyzes the collected work logs to identify patterns in worker movements and work procedures. For example, if a worker consistently takes the same route, it determines whether that route is optimal and proposes a more efficient alternative. Furthermore, when multiple workers perform tasks simultaneously, it optimizes their paths to prevent crossing. An anomaly detection function can also detect operations deviating from the normal workflow and alert the worker.

The generation unit proposes optimal movements and work procedures to workers based on analysis results. For example, when workers pick items, it provides navigation to ensure they take the shortest route, thereby reducing travel distance. When picking multiple items simultaneously, it suggests the most efficient order to support efficient operations. During packing, it proposes efficient procedures to increase work speed. When picking multiple items simultaneously, it suggests the optimal sequence to support efficient work. For packaging tasks, it proposes efficient procedures to increase work speed. Specific examples of prompts fed to the generative AI include: "Suggest the optimal sequence for workers when picking items" and "Propose efficient procedures for packaging tasks."

The learning unit receives feedback from workers and continuously learns to improve the proposal accuracy of the generation unit. It records whether workers accepted a proposal and whether the proposal was helpful, reflecting this in future proposals. For example, if a worker frequently accepts a specific proposal, the system adjusts to make that proposal more frequently. Furthermore, if a worker rejects a proposal, the system analyzes the reason and incorporates this into future proposals. Additionally, it can detect changes in the work environment within the logistics center and dynamically update proposal content accordingly.

In this way, the system comprehensively supports operations within the logistics center, enabling operational efficiency improvements. Its purpose is to reduce worker burden and enhance overall productivity. As a specific example, when a worker handles a new product, the system can propose the optimal picking sequence based on historical data for similar products. Furthermore, when a worker processes multiple orders simultaneously, the system automatically lists priority tasks for each order, supporting efficient work. In this way, the system aims to optimize operations within the logistics center, providing an experience akin to having a personal assistant.

The specific processing unit 290 transmits the results of the specific processing to the smart device 14. On the smart device 14, the control unit 46A instructs the output device 40 to output the results of the specific processing. The microphone 38B acquires audio indicating user input regarding the results of the specific processing. The control unit 46A transmits the audio data indicating the user input acquired by the microphone 38B to the data processing unit 12. At the data processing unit 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples.. Furthermore, AI may be implemented as an AI agent. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the acquisition unit is implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the smart device 14.

### Second Embodiment

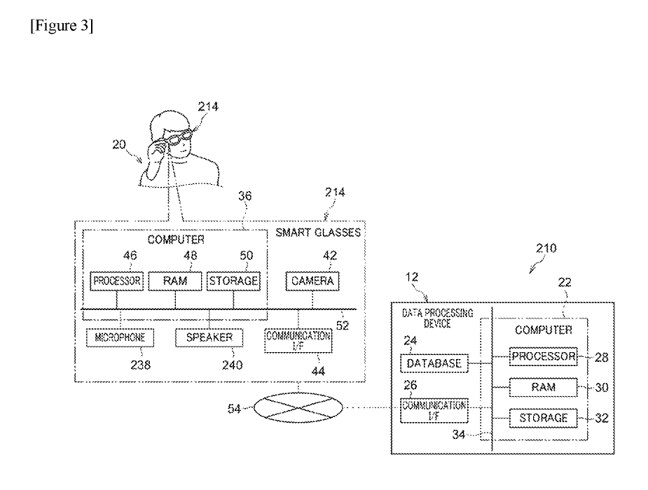

FIG. 3 shows an example configuration of the data processing system 210 according to the second embodiment.

As shown in FIG. 3, the data processing system 210 includes a data processing device 12 and smart glasses 214. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The smart glasses 214 include a computer 36, a microphone 238, a speaker 240, a camera 42, and a communication I/F b. The computer 36 includes a processor 46, RAM 48, and storage 50. Processor 46, RAM 48, and storage 50 are connected to bus 52. Microphone 238, speaker 240, and camera 42 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

Camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., within a field of view equivalent to that of a typical healthy individual).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

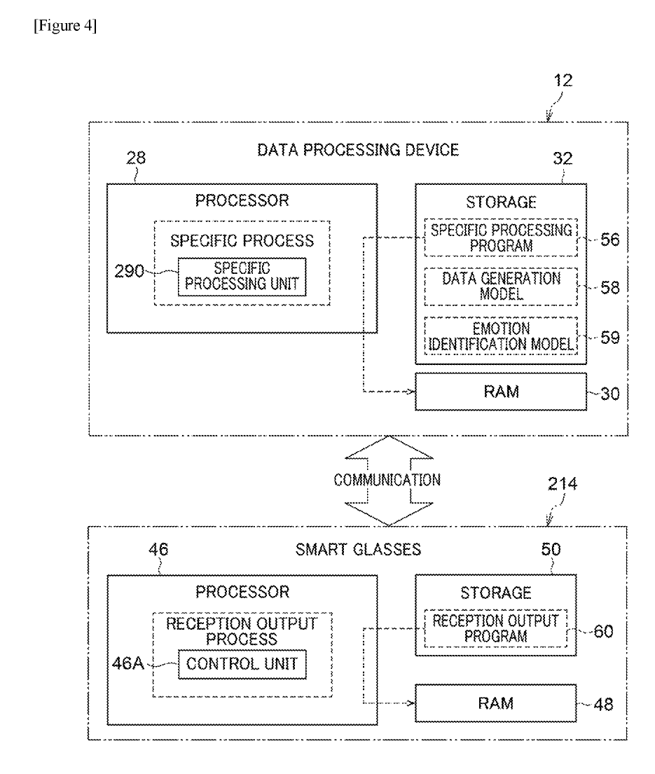

FIG. 4 illustrates an example of key functions of the data processing device 12 and the smart glasses 214. As shown in FIG. 4, specific processing is performed by the processor 28 within the data processing device 12. The specific processing program 56 is stored in the storage 32.

The specific processing program 56 is an example of a "program" related to the technology of this disclosure. Processor 28 reads the specific processing program 56 from storage 32 and executes the read specific processing program 56 on RAM 30. The specific processing is realized by processor 28 operating as specific processing unit 290 according to the specific processing program 56 executed on RAM 30.

Storage 32 stores a data generation model 58 and an emotion identification model 59. The data generation model 58 and emotion identification model 59 are used by specific processing unit 290. Specific processing unit 290 can estimate a user's emotion using emotion identification model 59 and perform specific processing using the user's emotion. The emotion estimation function (emotion identification function) using the emotion identification model 59 performs various estimations and predictions concerning the user's emotion, including estimation and prediction of the user's emotion, but is not limited to such examples. Furthermore, estimation and prediction of emotion also includes, for example, analysis (parsing) of emotion.

In the smart glasses 214, the processor 46 performs the reception output processing. The reception output program 60 is stored in the storage 50. The processor 46 reads the reception output program 60 from the storage 50 and executes the read reception output program 60 on the RAM 48. The reception output processing is realized by the processor 46 operating as the control unit 46A according to the reception output program 60 executed on the RAM 48. The reception output processing is realized by the processor 46 operating as a control unit 46A according to the reception output program 60 executed on RAM 48. Note that the smart glasses 214 may also have a data generation model 58 and an emotion identification model 59, and can perform processing similar to that of the identification processing unit 290 using these models.

Next, the specific processing performed by the specific processing unit 290 of the data processing device 12 will be described. The various parts of the system described below are implemented by the data processing device 12 and the smart glasses 214. In the following description, the data processing device 12 is referred to as the "server," and the smart glasses 214 are referred to as the "terminal."

### Example 1

The flow of the specific processing in Example 1 described in the first embodiment is the same as described above, so the explanation is omitted.

### Application Example 1

The flow of the specific processing in Example 1 described in the first embodiment is the same as described above, so the explanation is omitted.

The specific processing unit 290 transmits the result of the specific processing to the smart glasses 214. In the smart glasses 214, the control unit 46A causes the speaker 240 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

The data generation model 58 is a so-called generative AI (Artificial Intelligence). An example of the data generation model 58 is ChatGPT (registered trademark) (Internet search <URL: https://openai.com/blog/chatgpt>). The data generation model 58 is obtained by performing deep learning on a neural network. The data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while using the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned parts is performed by AI, that processing is performed in part or in whole by AI, but is not limited to this example. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12. However, the technology disclosed herein is not limited to this, and specific processing may also be performed by the smart glasses 214.

### Third Embodiment

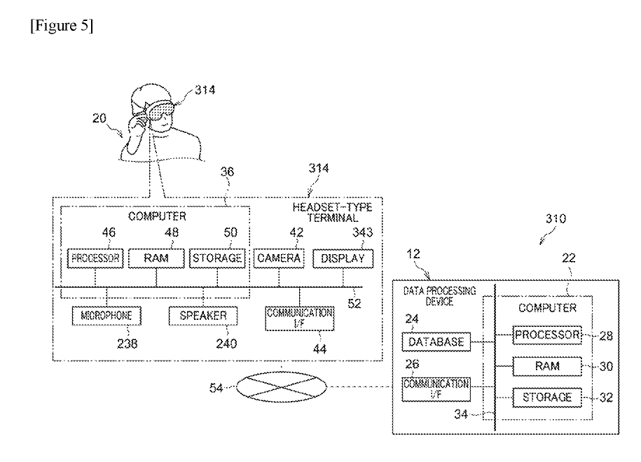

FIG. 5 shows an example configuration of the data processing system 310 according to the third embodiment.

As shown in FIG. 5, the data processing system 310 includes a data processing device 12 and a headset-type terminal 314. An example of the data processing device 12 is a server.

The data processing device 12 includes a computer 22, a database 24, and a communication I/F 26. The computer 22 is an example of a "computer" according to the technology of the present disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

The headset-type terminal 314 comprises a computer 36, a microphone 238, a speaker 240, a camera 42, a communication interface 44, and a display 343. The computer 36 includes a processor 46, RAM 48, and storage 50. The processor 46, RAM 48, and storage 50 are connected to a bus 52. The microphone 238, speaker 240, camera 42, and display 343 are also connected to the bus 52.

Microphone 238 receives voice input from user 20 to accept instructions and the like from user 20. Microphone 238 captures the voice input from user 20, converts the captured voice into audio data, and outputs it to processor 46. Speaker 240 outputs audio according to instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures images of the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

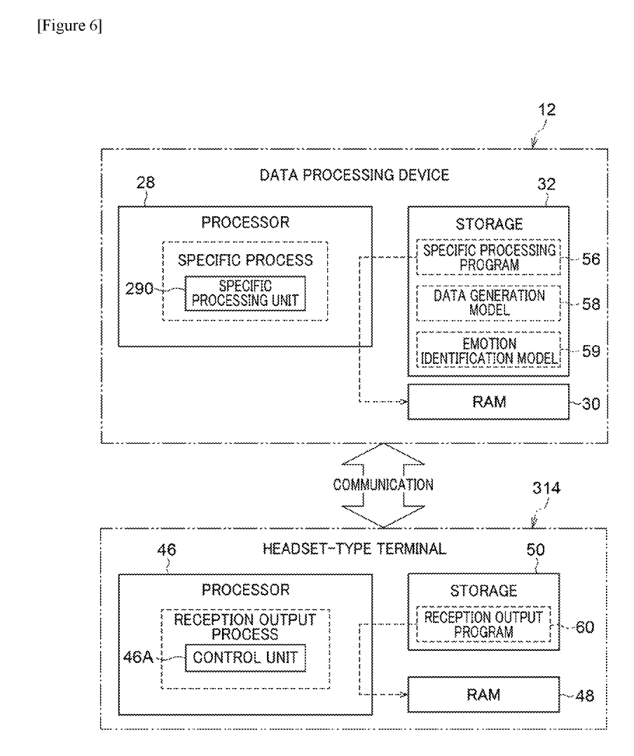

FIG. 6 shows an example of the main functions of the data processing device 12 and the headset-type terminal 314. As shown in FIG. 6, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by specific processing unit 290.

In the headset-type terminal 314, reception output processing is performed by the processor 46. The reception output program 60 is stored in the storage 50. Processor 46 reads the reception output program 60 from storage 50 and executes the read reception output program 60 on RAM 48. Reception output processing is achieved by processor 46 operating as control unit 46A according to the reception output program 60 executed on RAM 48.

Next, the specific processing performed by the specific processing unit 290 of the data processing device 12 is described. The various parts of the system described below are implemented by the data processing device 12 and the headset-type terminal 314. In the following description, the data processing device 12 is referred to as the "server," and the headset-type terminal 314 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the headset-type terminal 314. At the headset-type terminal 314, the control unit 46A causes the speaker 240 and the display 343 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is a so-called generative AI (Artificial Intelligence). An example of a data generation model 58 is ChatGPT (registered trademark) (Internet search <URL: https://openai.com/blog/chatgpt>). Data Generation Model 58 is obtained by performing deep learning on a neural network. Data Generation Model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12 and the like may include multiple types of data generation models 58. The data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12. However, the technology disclosed herein is not limited to this, and specific processing may also be performed by the headset-type terminal 314.

### Fourth Embodiment

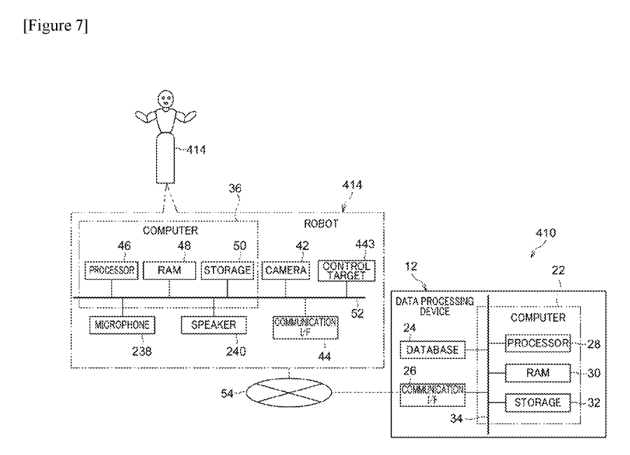

FIG. 7 shows an example configuration of the data processing system 410 according to the fourth embodiment.

As shown in FIG. 7, the data processing system 410 includes a data processing device 12 and a robot 414. An example of the data processing device 12 is a server.

The data processing device 12 includes a computer 22, a database 24, and a communication I/F 26. The computer 22 is an example of a "computer" related to the technology of this disclosure. The computer 22 includes a processor 28, RAM 30, and storage 32. The processor 28, RAM 30, and storage 32 are connected to a bus 34. The database 24 and communication I/F 26 are also connected to the bus 34. The communication I/F 26 is connected to a network 54. An example of the network 54 include a WAN (Wide Area Network) and/or a LAN (Local Area Network).

Robot 414 includes a computer 36, a microphone 238, a speaker 240, a camera 42, a communication interface 44, and a control target 443. Computer 36 includes a processor 46, RAM 48, and storage 50. Processor 46, RAM 48, and storage 50 are connected to bus 52. Furthermore, microphone 238, speaker 240, camera 42, and controlled object 443 are also connected to bus 52.

Microphone 238 receives voice input from user 20 to accept instructions or other commands. Microphone 238 captures the voice input from user 20, converts the captured voice into audio data, and outputs it to processor 46. Speaker 240 outputs audio in accordance with instructions from processor 46.

The camera 42 is a compact digital camera equipped with an optical system, such as a lens, aperture, and shutter, and an imaging element, such as a CMOS (Complementary Metal-Oxide-Semiconductor) image sensor or a CCD (Charge Coupled Device) image sensor. It captures the user's surroundings (e.g., an imaging range defined by a field of view equivalent to that of a typical healthy person).

The communication I/F 44 is connected to the network 54. The communication I/Fs 44 and 26 manage the exchange of various information between processor 46 and processor 28 via network 54. The exchange of various information between processor 46 and processor 28 using communication I/F 44 and 26 is performed in a secure state.

The control target 443 includes a display device, LEDs for the eye section, and motors for driving the arms, hands, legs, etc. The posture and gestures of robot 414 are controlled by controlling the motors for the arms, hands, legs, etc. Part of the robot 414's emotions can be expressed by controlling these motors. Furthermore, the robot 414's facial expressions can also be expressed by controlling the light emission state of the LEDs in its eyes.

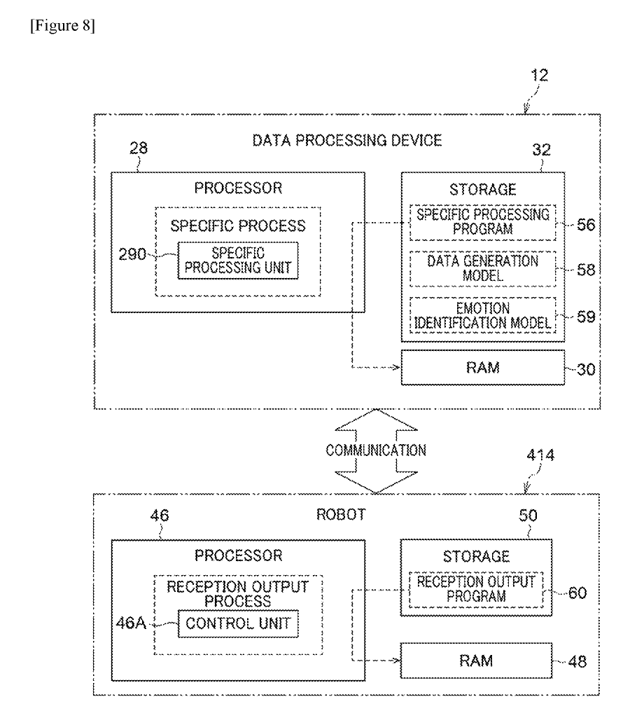

FIG. 8 shows an example of the main functions of the data processing device 12 and the robot 414. As shown in FIG. 8, specific processing is performed by the processor 28 in the data processing device 12. The specific processing program 56 is stored in the storage 32.

The specific processing program 56 is an example of a "program" related to the technology of this disclosure. The processor 28 reads the specific processing program 56 from the storage 32 and executes the read specific processing program 56 on the RAM 30. The specific processing is realized by the processor 28 operating as a specific processing unit 290 according to the specific processing program 56 executed on the RAM 30.

Storage 32 stores a data generation model 58 and an emotion identification model 59. The data generation model 58 and the emotion identification model 59 are used by the specific processing unit 290.

In robot 414, reception output processing is performed by processor 46. Storage 50 stores a reception output program 60. Processor 46 reads the reception output program 60 from storage 50 and executes the read reception output program 60 on RAM 48. Reception output processing is realized by the processor 46 operating as a control unit 46A according to the reception output program 60 executed on RAM 48.

Next, the specific processing performed by the specific processing unit 290 of the data processing device 12 is described. The various parts of the system described below are realized by the data processing device 12 and the robot 414. In the following description, the data processing device 12 is referred to as the "server," and the robot 414 is referred to as the "terminal."

### Example 1

The flow of the specific processing is the same as that described in Example 1 of the first embodiment, so the description is omitted.

### Application Example 1

The flow of the specific processing in Example 1 described in the above first embodiment is the same, so the explanation is omitted.

The specific processing unit 290 transmits the result of the specific processing to the robot 414. In the robot 414, the control unit 46A causes the speaker 240 and the control target 443 to output the result of the specific processing. The microphone 238 acquires audio indicating user input regarding the result of the specific processing. The control unit 46A transmits the audio data indicating the user input acquired by the microphone 238 to the data processing device 12. At the data processing device 12, the specific processing unit 290 acquires the audio data.

Data Generation Model 58 is what is known as generative AI (Artificial Intelligence). An example of a data generation model 58 is ChatGPT (registered trademark) (Internet search <URL: https://openai.com/blog/chatgpt>). Data generation model 58 is obtained by performing deep learning on a neural network. Data generation model 58 receives input of a prompt containing instructions, as well as inference data such as audio data representing sound, text data representing text, and image data (e.g., still image data or video data) representing images. The data generation model 58 infers based on the input inference data according to the instructions indicated by the prompt and outputs the inference result in one or more data formats, such as audio data, text data, and image data. The data generation model 58 includes, for example, text generation AI, image generation AI, and multimodal generation AI. Here, inference refers to, for example, analysis, classification, prediction, and/or summarization. The specific processing unit 290 performs the aforementioned specific processing while utilizing the data generation model 58. The data generation model 58 may be a fine-tuned model capable of outputting inference results from prompts that do not contain instructions. In this case, the data generation model 58 can output inference results from prompts that do not contain instructions. The data processing device 12, etc., includes multiple types of data generation models 58, and the data generation model 58 includes AI other than generative AI. AI other than generative AI includes, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others. The AI may perform various processing operations, but is not limited to such examples. Furthermore, the AI may be an AI agent. Also, when the processing of the aforementioned components is performed by AI, that processing may be performed in part or in whole by AI, but is not limited to such examples. Furthermore, processing performed by AI, including generative AI, may be replaced by rule-based processing, and rule-based processing may be replaced by processing performed by AI, including generative AI.

Furthermore, the processing performed by the data processing system 10 described above is executed by either the specific processing unit 290 of the data processing device 12 or the control unit 46A of the smart device 14, but it may also be executed by both the specific processing unit 290 of the data processing device 12 and the control unit 46A of the smart device 14. Furthermore, the specific processing unit 290 of the data processing device 12 acquires or collects information necessary for processing from the smart device 14 or external devices, etc., and the smart device 14 acquires or collects information necessary for processing from the data processing device 12 or external devices, etc.

For example, the collection unit may be implemented by the control unit 46A of the smart device 14 or the specific processing unit 290 of the data processing device 12. For example, the acquisition unit acquires step count data using the camera 42 or communication I/F 44 of the smart device 14, and this data is processed by the specific processing unit 290 of the data processing device 12. For example, the analysis unit is implemented by the specific processing unit 290 of the data processing device 12 and analyzes data from the collection unit and acquisition unit. For example, the generation unit is implemented by the specific processing unit 290 of the data processing device 12 and generates a cooking menu using a generation AI. For example, the provision unit is implemented by the output device 40 of the smart device 14 or the specific processing unit 290 of the data processing device 12 and provides the generated cooking menu to the user. The correspondence between each unit and the device or control unit is not limited to the above examples and various modifications are possible.

The above embodiment described a form where specific processing is performed by the data processing device 12, but the technology disclosed herein is not limited thereto; specific processing may also be performed by the robot 414.

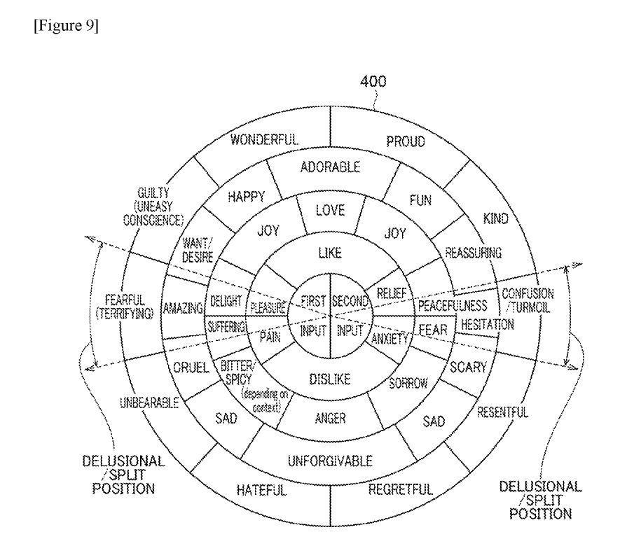

The emotion identification model 59, functioning as an emotion engine, may determine the user's emotion according to a specific mapping. Specifically, the emotion identification model 59 may determine the user's emotion according to an emotion map (see FIG. 9), which is a specific mapping. Furthermore, the emotion identification model 59 may similarly determine the robot's emotion, and the specific processing unit 290 may perform specific processing using the robot's emotion.

FIG. 9 is a diagram showing an emotion map 400 where multiple emotions are mapped. In the emotion map 400, emotions are arranged radially in concentric circles from the center. Emotions closer to the center of the concentric circles represent more primitive states. Emotions representing states or behaviors arising from mental states are placed further out in the concentric circles. Emotion is a concept encompassing affect and mental states. Generally, emotions generated from reactions occurring within the brain are placed on the left side of the concentric circles. Generally, emotions induced by situational judgment are placed on the right side of the concentric circles. Generally, emotions generated from reactions occurring within the brain and also induced by situational judgment are placed in the upper and lower directions of the concentric circles. Additionally, the upper part of the concentric circle houses "pleasant" emotions, while the lower part houses "unpleasant" emotions. Thus, in Emotion Map 400, multiple emotions are mapped based on the structure where emotions arise. Emotions that tend to occur simultaneously are mapped close together.

These emotions are distributed around the 3 o'clock position on Emotion Map 400, typically oscillating between feelings of security and anxiety. In the right half of Emotion Map 400, situational awareness takes precedence over internal sensations, resulting in a calmer impression.

The inner part of Emotion Map 400 represents the mind, while the outer part represents behavior. Therefore, the further outward one goes on Emotion Map 400, the more visible the emotion becomes (manifesting in behavior).

Here, human emotions are based on various balances, such as posture and blood sugar levels. When these balances deviate from the ideal, it indicates a state of discomfort; when they approach the ideal, it indicates a state of comfort. Similarly, for robots, automobiles, motorcycles, etc., emotions can be created based on various balances, such as posture and battery level. When these balances deviate from the ideal, it indicates a state of discomfort; when they approach the ideal, it indicates a state of comfort. The emotion map is, for example, Dr. Mitsuyoshi's Emotion Map (Based on research on speech emotion recognition and brain physiological signal analysis systems for emotions, Tokushima University, Doctoral Dissertation: https://ci.nii.ac.jp/naid/500000375379). The left half of the emotion map displays emotions belonging to the "Reaction" domain, where sensory aspects predominate. The right half of the emotion map displays emotions belonging to the "Situation" domain, where situational awareness is dominant.

Two emotions that promote learning are defined in the emotion map. One is the negative emotion around the center of the "repentance" or "reflection" area on the situation side. That is, when the robot experiences negative emotions like "I never want to feel this way again" or "I don't want to be scolded anymore." The other is the positive emotion around "desire" on the reaction side. That is, when the robot feels positive emotions like "I want more" or "I want to know more."

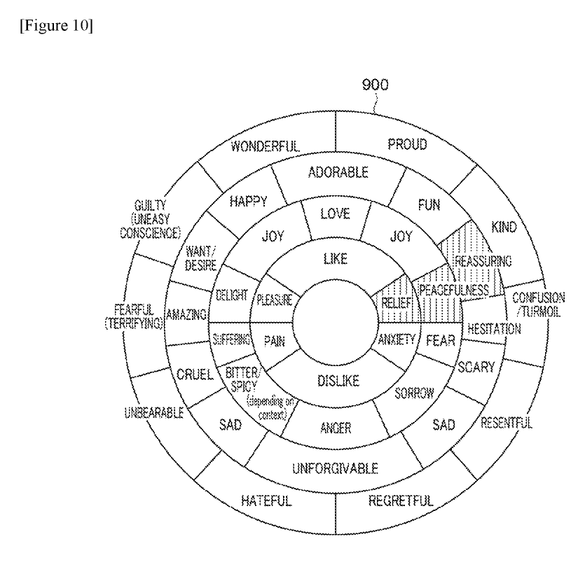

The emotion identification model 59 inputs the user input into a pre-trained neural network, obtains emotion values corresponding to each emotion shown in the emotion map 400, and determines the user's emotion. This neural network is pre-trained based on multiple training data sets, which are combinations of user input and emotion values corresponding to each emotion shown in the emotion map 400. Furthermore, this neural network is trained such that emotions positioned close to each other, as shown in the emotion map 900 in FIG. 10, have similar values. FIG. 10 illustrates an example where multiple emotions, such as "reassurance," "tranquility," and "encouragement," have similar emotion values.

The above description primarily explains the system according to the present disclosure in terms of the functions of the data processing device 12. However, the system according to the present disclosure is not necessarily implemented on a server. The system according to the present disclosure may be implemented as a general information processing system. For example, the present disclosure may be implemented as a software program operating on a personal computer or as an application operating on a smartphone or the like. The method according to the present disclosure may be provided to users in a SaaS (Software as a Service) format.

The above embodiments illustrated a configuration where specific processing is performed by a single computer 22. However, the technology of this disclosure is not limited thereto. Distributed processing may be performed by multiple computers, including computer 22, for specific processing. For example, data generation model 58 may be provided in an external device of data processing device 12, and said external device may generate data corresponding to input data. For example, the data generation model 58 may be provided in an external device of the data processing device 12, and data generation corresponding to input data may be performed in said external device.

The above embodiment described a configuration where a specific processing program 56 is stored in storage 32, but the technology disclosed herein is not limited to this. For example, the specific processing program 56 may be stored on a portable computer-readable non-volatile storage medium such as a USB (Universal Serial Bus) memory. The specific processing program 56 stored on the non-volatile storage medium may be stored on a portable USB memory or similar device. The specific processing program 56 stored on the non-volatile storage medium is installed on the computer 22 of the data processing device 12. The processor 28 executes the specific processing according to the specific processing program 56.

Alternatively, the specific processing program 56 may be stored on a storage device, such as a server, connected to the data processing device 12 via the network 54. Upon request from the data processing device 12, the specific processing program 56 may be downloaded and installed on the computer 22.

It should be noted that it is not necessary to store the entire specific processing program 56 on a storage device such as a server connected to the data processing device 12 via the network 54, or to store the entire specific processing program 56 in the storage 32. It is also possible to store only a portion of the specific processing program 56.

Various types of processors can be used as hardware resources to execute the specific processing. Examples of processors include a CPU, which is a general-purpose processor that functions as a hardware resource for executing specific processing by executing software, i.e., a program. Additionally, processors may include dedicated electronic circuits, such as FPGAs (Field-Programmable Gate Array), PLDs (Programmable Logic Device), or ASICs (Application Specific Integrated Circuit), which are processors with circuit configurations specifically designed to execute particular processing tasks. Each processor incorporates or connects to memory, and each processor executes specific processing by utilizing this memory.

The hardware resources for executing specific processing may be comprised of one of these various processors, or may be comprised of a combination of two or more processors of the same or different types (e.g., a combination of multiple FPGAs, or a combination of a CPU and an FPGA). Furthermore, the hardware resources for executing specific processing may be a single processor.

Examples of configurations using a single processor include: First, a configuration where one processor is formed by combining one or more CPUs with software, with this processor functioning as the hardware resource executing specific processing. Second, there is a form using a processor that implements the entire system functionality, including multiple hardware resources executing specific processing, on a single IC chip, as exemplified by a System-on-a-chip (SoC). Thus, specific processing is implemented using one or more of the above various processors as hardware resources.

Furthermore, regarding the hardware structure of these various processors, more specifically, electrical circuits combining circuit elements such as semiconductor devices can be used. Also, the specific processing described above is merely one example. Therefore, it goes without saying that within the scope not deviating from the main purpose, unnecessary steps may be omitted, new steps may be added, or the processing order may be changed.

The above description and illustrations provide a detailed explanation of the aspects pertaining to the technology of this disclosure and represent merely one example of the technology disclosed herein. For example, the above descriptions of the configuration, functions, actions, and effects are merely examples of the configuration, functions, actions, and effects pertaining to the technology disclosed herein. Therefore, it goes without saying that within the scope that does not deviate from the main purpose of the technology disclosed herein, unnecessary portions may be omitted, new elements may be added, or replacements may be made to the above-described content and illustrated content. Furthermore, to avoid confusion and facilitate understanding of the portion pertaining to the technology disclosed herein, descriptions of technical common knowledge and the like that are not particularly necessary for enabling the implementation of the technology disclosed herein have been omitted from the above-described content and illustrated content. To facilitate understanding of the technical aspects of the present disclosure, descriptions of common technical knowledge and the like that are not particularly necessary for enabling the implementation of the present disclosure have been omitted from the above descriptions and illustrations.

All literature, patent applications, and technical specifications cited herein are incorporated by reference to the same extent as if each individual literature, patent application, and technical specification were specifically and individually cited herein.

Regarding the above embodiments, the following is further disclosed.

### Supplementary Note 1

A system comprising a monitoring unit, an analysis unit, a generation unit, and a learning unit. The monitoring unit monitors workers' movements and work procedures within a logistics center in real time, collecting work logs using sensors and cameras. The analysis unit analyzes the collected work logs using machine learning algorithms to identify patterns in workers' movements and work procedures. The generation unit proposes optimal movements and work procedures to workers based on the analysis results, supporting efficient task execution. The Learning Unit receives feedback from workers and continuously learns to improve the accuracy of the Generation Unit's proposals.

A system as described in Supplementary Note 1, wherein the monitoring unit uses sensors and cameras installed within the logistics center to record workers' movements and work procedures in detail, monitoring which shelves workers pick items from, which routes they take when moving, and how they package items and prepare them for shipment.

A system as described in Supplementary Note 1, wherein the generation unit proposes optimal movements and work procedures to workers based on analysis results obtained from the analysis unit, for example, proposing to optimize picking order to shorten travel distance and reduce work time, and further proposing efficient procedures for packaging work.

### EXPLANATION OF SYMBOLS

10, 210, 310, 410 Data Processing System

12 Data Processing Device

14 Smart Device

214 Smart Glasses

314 Headset-type Terminal

414 Robot

What is claimed is:

1. An interactive content generation system comprising:
a server device including:
at least one processor;
a non-transitory storage storing executable instructions, a trained content generation model, and a user state prediction model; and
a communication interface configured to communicate with a plurality of client devices over a network;
wherein the at least one processor, upon execution of the executable instructions, is configured to:
receive, from a client device, real-time interaction data generated during execution of a digital environment, the interaction data including at least one of user input events, navigation patterns, dwell time measurements, or selection history;
generate a structured user state representation from the real-time interaction data, the structured user state representation including behavioral features and contextual parameters;
input the structured user state representation into the trained content generation model to generate modified digital content adapted to the structured user state representation;
transmit the modified digital content to the client device for rendering within the digital environment;
receive subsequent interaction data corresponding to the modified digital content; and
update at least one parameter of the structured user state representation or the content generation model using the user state prediction model trained on accumulated historical interaction data, thereby forming a closed-loop adaptive interaction control process.

2. The system of claim 1, wherein the structured user state representation includes an engagement score computed from weighted interaction features.

3. The system of claim 1, wherein the trained content generation model comprises a neural network configured to generate at least one of graphical elements, text elements, or multimedia elements.

4. The system of claim 1, wherein updating includes adjusting a content presentation parameter comprising layout configuration, animation intensity, color scheme, or information density.

5. The system of claim 1, wherein the user state prediction model predicts a probability of session termination or conversion based on the structured user state representation.

6. The system of claim 1, wherein the server device maintains a session identifier linking transmitted modified digital content with corresponding subsequent interaction data.

7. A computer-implemented method executed by at least one processor of a server device, comprising:
receiving real-time interaction data from a client device during execution of a digital environment;
extracting behavioral features and contextual parameters from the real-time interaction data;
generating a structured user state representation including the behavioral features and contextual parameters;
executing a trained content generation model using the structured user state representation to generate adaptive digital content;
transmitting the adaptive digital content to the client device;
monitoring interaction data corresponding to the adaptive digital content; and
updating at least one adaptive control parameter based on the monitored interaction data using a trained user state prediction model.

8. The method of claim 7, wherein extracting behavioral features includes calculating dwell time statistics and interaction frequency metrics.

9. The method of claim 7, wherein generating adaptive digital content includes modifying at least one of interface layout, media playback characteristics, or content sequencing.

10. The method of claim 7, further comprising generating a plurality of candidate adaptive digital contents and selecting one candidate based on a predicted engagement metric.

11. The method of claim 7, wherein updating includes performing reinforcement learning to optimize a reward function representing user engagement.

12. The method of claim 7, further comprising storing the structured user state representation and corresponding engagement outcomes in a database for periodic retraining of the user state prediction model.

13. A non-transitory computer-readable storage medium storing instructions that, when executed by at least one processor of a server device, cause the at least one processor to:
receive real-time interaction data associated with a digital environment executed on a client device;
generate a structured user state representation from the interaction data;
execute a trained content generation model to generate adaptive digital content based on the structured user state representation;
transmit the adaptive digital content to the client device;
receive additional interaction data corresponding to the adaptive digital content; and
update at least one adaptive control parameter using a trained user state prediction model based on the additional interaction data.

14. The non-transitory computer-readable storage medium of claim 13, wherein the structured user state representation includes at least one temporal feature representing a rate of user interaction.

15. The non-transitory computer-readable storage medium of claim 13, wherein the trained content generation model comprises a transformer-based generative model.

16. The non-transitory computer-readable storage medium of claim 13, wherein updating includes modifying a probability distribution used to select subsequent content elements.

17. The non-transitory computer-readable storage medium of claim 13, wherein the instructions further cause the processor to perform A/B testing across multiple adaptive content variants.

18. The non-transitory computer-readable storage medium of claim 13, wherein the adaptive digital content includes personalized multimedia content generated in real time.
